(19) United States
(12) Patent Application Publication
(10) Pub. No.: US 2003/0095152 A1
(43) Pub. Date: May 22, 2003

(54) Flat panel digital picture frame

(76) Inventor: Avery Fong, Castro Valley, CA (US)

Correspondence Address: HICKMAN PALERMO TRUONG & BECKER, LLP, 1600 WILLOW STREET, SAN JOSE, CA, 95125, US

(21) Appl. No.: 09/952,277

(22) Filed: Sep. 13, 2001

(51) Int. Cl. G09G 5/00

(52) U.S. Cl. 345/838

(57) ABSTRACT

A method and system for displaying digital images on a flat panel display unit is described. In one aspect, one or more digital image files received and a thumbnail image for each of said one or more digital image files is displayed within the a flat panel display unit. A first user input is received that selects one or more of said thumbnail images and a second user input is received that selects a particular mode for displaying images that associated with the selected one or more thumbnail images. The one or more images that are associated with said one or more selected thumbnail images are then displayed within the flat panel display unit based on the selected display mode.

### FIELD OF THE INVENTION

The present invention generally relates to the displaying of digital information. The invention relates more specifically to providing a flat panel display mechanism for displaying digital images in a picture frame style.

### BACKGROUND OF THE INVENTION

In a home or any building (e.g. office or commercial), pictures are hung on the walls in different rooms based upon a person's taste and the décor of the rooms. On some occasions, for many different reasons, it may be disable to replace or substitute a new picture for one that is currently being displayed. For example, if a new baby is born into a family, the family may desire to display a picture of the baby for everyone to view. Similarly, a company that comes out with a new product may wish to replace a picture of the old product with a picture of the new product.

A drawback with wanting to replace an old picture with a new picture is that it can be expensive to purchase a new frame and to have the new picture framed and mounted onto the wall. Additionally, there is usually a question of what to do with the old picture. For example, should the old picture be stored somewhere in hopes that it won't be damaged in case it is ever desirable to display the picture again.

Based on the foregoing, there is a clear need for an improved mechanism that will allow users to easily replace old pictures with new pictures.

### SUMMARY OF THE INVENTION

A method and system for displaying digital images on a flat panel display unit is described. In one aspect, one or more digital image files received and a thumbnail image for each of said one or more digital image files is displayed within the flat panel display unit. A first user input is received that selects one or more of said thumbnail images and a second user input is received that selects a particular mode for displaying images that associated with the selected one or more thumbnail images. The one or more images that are associated with said one or more selected thumbnail images are then displayed within the flat panel display unit based on the selected display mode.

In other aspects, the invention encompasses a computer apparatus, a computer-readable medium, and a carrier wave configured to carry out the foregoing steps.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a flat panel display system in which certain embodiments of the invention may be utilized;

FIG. 2A is a block diagram that illustrates certain internal details of a flat panel display system;

FIG. 2B illustrates a block diagram of a flat panel display system that is connected to a network system;

FIG. 2C illustrates a flat panel display system that is connected to a computer system over a communication connection;

FIG. 3 illustrates an example of a flat panel display system in which a control panel is provided for controlling the specific digital images that are displayed within the flat panel display unit;

FIG. 4 illustrates an example computer system that may be included within a flat panel display system;

FIG. 5 illustrates a flat panel display system in which multiple picture images are simultaneously display within a flat panel display unit;

FIG. 6 illustrates an example of a flat panel display system in which multiple picture images are displayed in a slide-show format; and

FIG. 7 depicts a flow diagram that illustrates a set of steps that may be taken for displaying images on a flat panel display system.

### DETAILED DESCRIPTION OF THE PREFERRED EMBODIMENT

A method and apparatus for displaying images in a flat panel digital picture frame is described. In the following description, for the purposes of explanation, numerous specific details are set forth in order to provide a thorough understanding of the present invention. It will be apparent, however, to one skilled in the art that the invention may be practiced without these specific details. In other instances, well-known structures and devices are shown in block diagram form in order to avoid unnecessarily obscuring the invention.

### OPERATIONAL CONTEXT

A flat panel display mechanism is provided for displaying digital images within a picture frame. In one embodiment, the flat panel display mechanism includes a flat panel display unit that is bordered by a frame component. The flat panel display mechanism may be used to display digital images that may be encoded in various formats. In certain embodiments, the frame unit includes a set of picture selection controls that allows a user to select from a pool of images one or more pictures for display within the flat panel display unit.

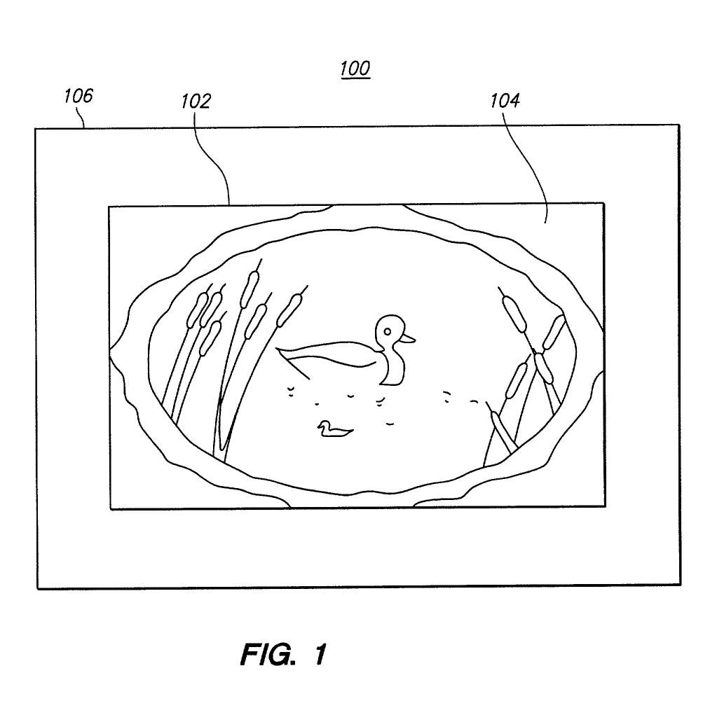

FIG. 1 illustrates an example of a flat panel display system 100 in which certain embodiments of the invention may be utilized. In this example, a frame 106 encloses, holds, and/or supports a flat panel display unit 102 that is currently being used to display a picture image 104. In certain embodiments, frame 106 is constructed from materials that are similar to those that are used in ordinary picture frames. For example, frame 106 may be constructed from a variety of materials that includes, but is not limited to wood, plastic, metal or any other material that has the capacity to support flat panel display unit 102. The flat panel display unit 102 may consist of any flat panel screen device that is capable of displaying digital images. For example, flat panel display unit 102 may represent a variety of different flat panel displays that are manufactured by various companies such as Fujitsu, DigitalView, and Planar Systems. The picture 104 that is displayed on the flat panel display unit 102 is based on digital information that may be of a variety of different digital formats, including but not limited to jpeg, mpeg, bmp, gif, tiff, or any other format that may be used to store digital information. In certain embodiments, a software application (not shown) is used to display the digital image of the picture 104 on the flat panel display unit 102.

### CONTROLLING THE DISPLAYING OF DIGITAL PICTURES

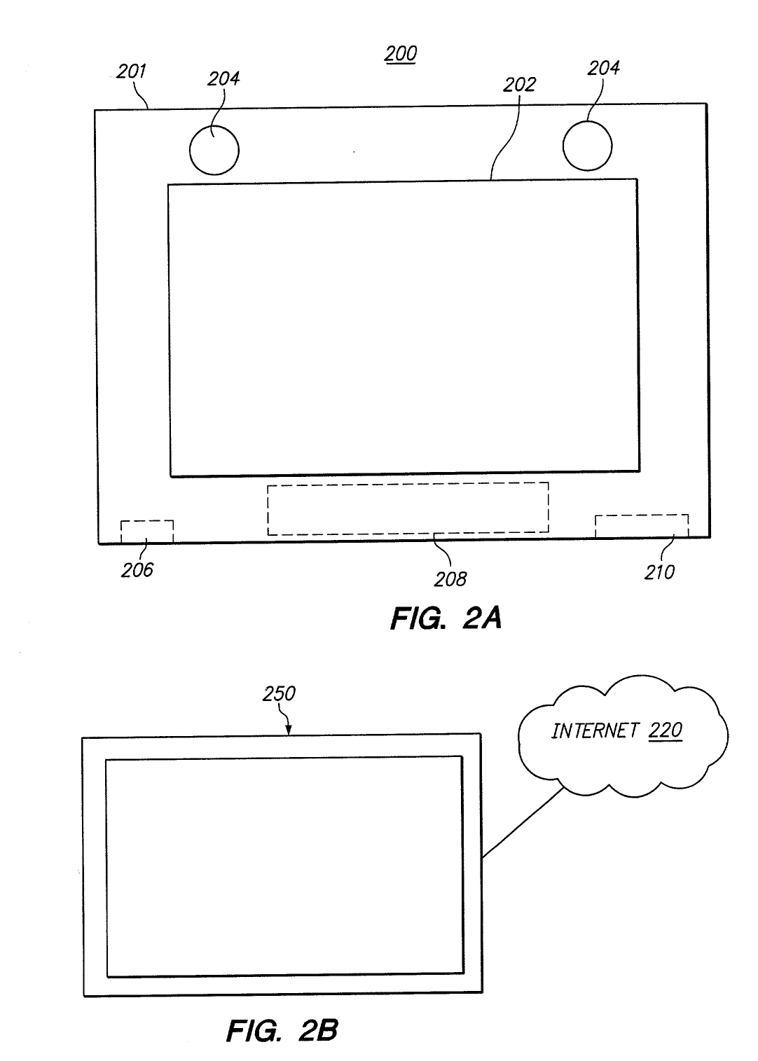

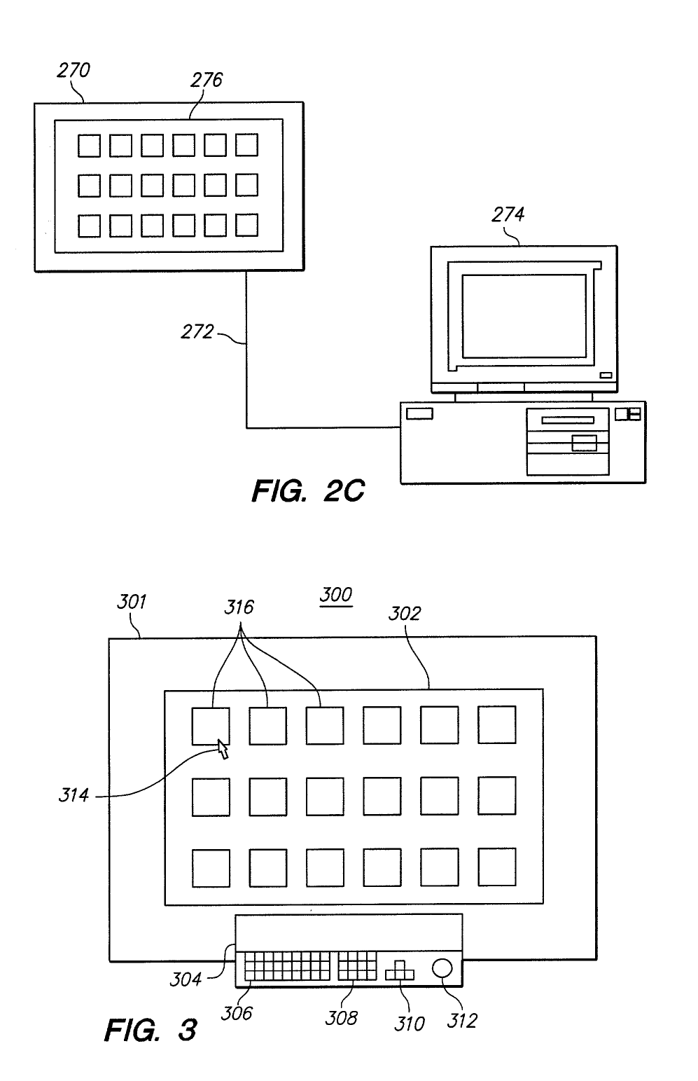

FIG. 2A is a block diagram that illustrates certain internal details of a flat panel display system 200 in accordance with certain embodiments of the invention. As depicted, a frame component 201 is configured to support a flat panel display unit 202 that is used for displaying one or more digital images. In this example, frame component 201 includes a set of speakers 204, a power control unit 206, a control panel 208 and a group of one or more ports 210.

Speakers 204 may represent a variety of different speaker components that are configured to play various audio sounds. In certain embodiments, the user may coordinate the particular audio that is being played by speakers 204 with the particular image that is being displayed within flat panel display unit 202. The audio sounds may be based on analog or digital data and may be received by speakers 204 through either a wire and/or wireless connection.

Power control unit 206 provides a mechanism for powering on and off the flat panel display system 200. In certain embodiments, power control unit 206 consists of a wireless power control that allows a user to remotely power on and off the flat panel display system 200.

Control panel 208 provides a set of display controls for controlling the particular image and/or images that are displayed within flat panel display unit 202. For example, control panel 208 may include an image selection mechanism that allows a user to scroll through a group of selectable images that may be displayed within flat panel display unit 202. In certain embodiments, the group of selectable images are displayed as thumbnail images within flat panel display unit 202. The user may then select a particular thumbnail image to cause a corresponding picture image to be displayed within flat panel display unit 202.

In one embodiment, control panel 208 allows the user to select how images are displayed within flat panel display unit 202 and a particular mode in which the images are to be displayed (i.e. single picture, multiple pictures, slide show). In addition, control panel 208 may include various other selectable user options. For example, control panel 208 may include controls for adjusting the lighting of the picture (i.e. brightness, contrast, tint), and/or the volume, bass, and treble of the music that is played through speakers 204.

In certain embodiments, control panel 208 is hidden within frame component 201. For example, control panel 208 may be concealed by a cover that is comprised of a material that is the same and/or similar to the texture and color that used in frame component 201.

Ports 210 provide an interface to other devices through which images may be uploaded into flat panel display system 200. For example, ports 210 may include a variety of different ports, including but not limited to serial, parallel, USB, or Ethernet ports. Ports 210 may be configured to receive information over a hard-wired wire communication mechanism, such as a phone line, Ethernet cable, firewire, etc., or over a wireless communication mechanism such as optical, infrared, bluetooth, or other compatible wireless communication mechanism.

FIG. 2B illustrates a block diagram of a flat panel display system 250 that is connected to a network system, such as Internet 220. In certain embodiments, by connecting flat panel display system 250 to one or more network systems, the content that is associated with the network may be made available to the user for displaying by the flat panel display system 250. For example, by retrieving one or more images that are stored within a server device that is connected to Internet 220, the user may be provided with an unlimited number of picture images for which they may select from. In certain embodiments, the flat panel display system 250 can be configured to automatically retrieve one or more images that are stored at a particular location on Internet 220. For example, a grandmother may configure the flat panel display system 250 to display the image that is currently stored on her son's web site. Thus, by updating the image file that is currently stored at web site, the son can remotely control the particular picture (for example, the particular picture of the grandchild) that is displayed by the grandmother's flat panel display system 250.

In addition to, or instead of a network system, flat panel display system may be connected to a computer device. For example, FIG. 2C illustrates a flat panel display system 270 that is connected to a computer 274 over a communication connection 272. In one embodiment, computer 274 controls the one or more images that are currently displayed on flat panel display system 270. For example, computer 274 may include software that allows a user to select one or more images that are stored within computer 274. In response to selecting the one or more images, image data is sent from the computer 274 to flat panel display system 270. Upon receiving the image data, flat panel display system 270 displays the one or more images within a flat panel display unit 276. In certain embodiments, flat panel display system 270 includes a storage unit, for example, RAM, flash memory, disk, etc., that is used to store the image data that is received from computer 274. For example, by storing the image data, flat panel display system 270 can independently refresh and/or rotate through the images that are displayed within flat panel display unit 276.

In another embodiment, computer 274 and flat panel display system 270 are configured in a “Master-Slave” environment in which computer 274 is responsible for refreshing and/or controlling the particular images that are currently displayed within flat panel display unit 276.

### CONTROLLING THE DISPLAY OF IMAGES

In certain embodiments, the flat panel display mechanism allows the user to display multiple picture images within the flat panel display unit. FIG. 3 illustrates an example of a flat panel display system 300 in which a control panel 304 is provided for controlling the specific digital images that are displayed within the flat panel display unit 302. As depicted, control panel 304 is hidden within the frame 301 and is folded out to show and allow use of its controls (i.e. keys and track ball). In this example, control panel 304 includes an alpha keypad 306, a numeric keypad 308, arrow keys 310, and a track ball 312 (collectively termed as “display controls”) for moving a cursor 314 on the flat panel display unit 302. Control panel 304 may include additional keys and/or control functions (not shown) that perform additional tasks. In one embodiment, the display controls allow the user to select a variety of display options, that may include but is not limited to, how the pictures are obtained (for example, what port to use), which pictures are to be displayed and how the pictures are displayed.

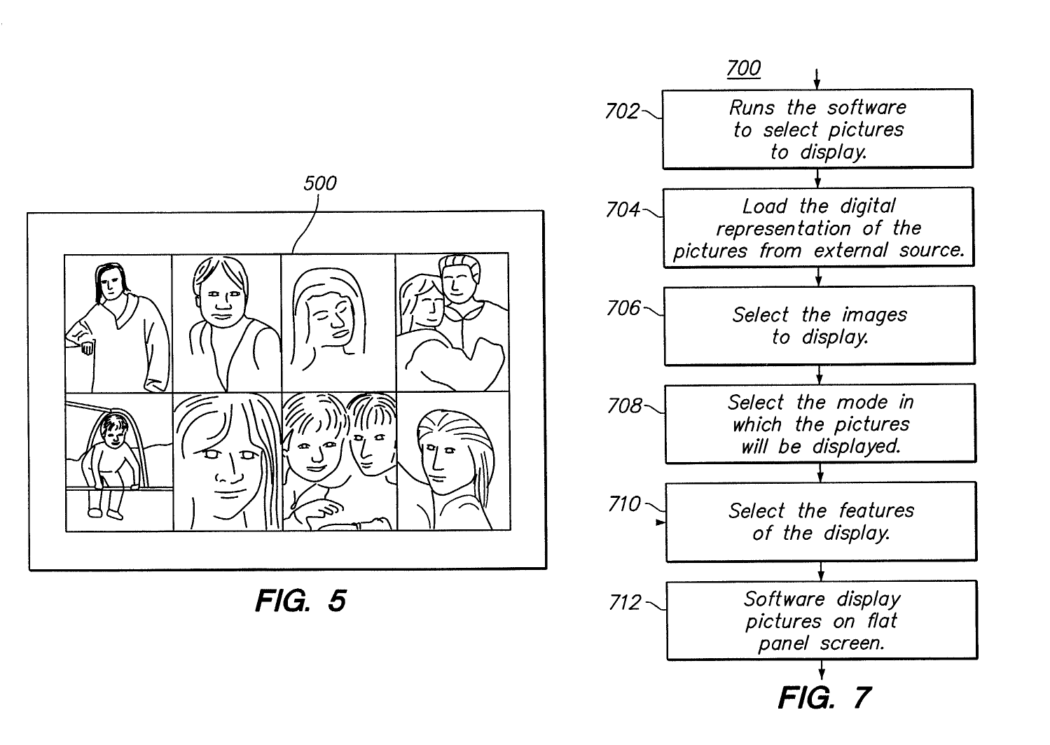

In certain embodiments, the flat panel display unit 302 serves as a screen for the control panel 304 to enable the user to select and control the specific images that are to be displayed. In one embodiment, frame component 301 includes one or more software components that allow the user to view and select the particular set of images that will be displayed on flat panel display unit 302. For example, a variety of application software, such as Kodak Portraits & More PC Event Software, Canon Utilities ZoomBrowser EX, Arcsoft cePhoto, may execute within frame component 301 to allow a user to organize, view, and select the pictures that they would like to display. In this example, the application software has displayed a set of thumbnail images 316, within a window, that allow the user to choose one or more picture images for display within flat panel display unit 302. By interacting with the application software the user can cause the flat panel display system 300 to display a single picture, multiple pictures, or multiple pictures one at a time (for example, a slide-show type presentation). For example, FIG. 5 illustrates a flat panel display system 500 in which multiple picture images are simultaneously display within a flat panel display unit.

In certain embodiments, the user can select a specific time duration for which an image is to be displayed within flat panel display unit 302. For example, the user may choose to rotate through a group of ten images with each image being displayed for a period of two hours.

### HARDWARE OVERVIEW

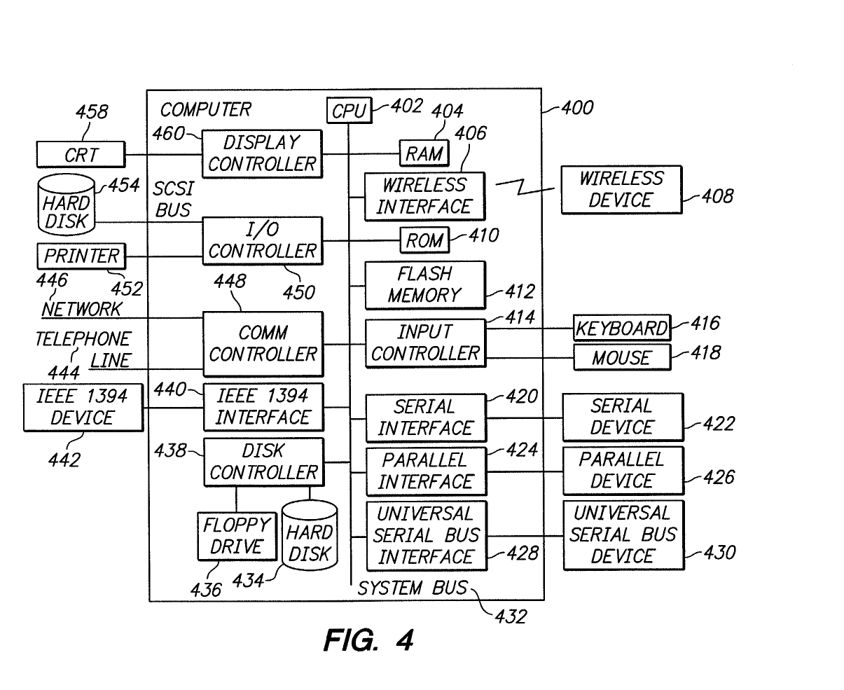

FIG. 4 illustrates an example computer system 400 that may be included in the frame component for performing the functions that have been illustrated in the previous figures. In this example, the computer system 400 includes a CPU 402 which may be implemented as any type of processor, including commercially available microprocessors from companies such as Intel, AMD, Motorola, Hitachi and NEC. Also included is a working memory, such as a RAM 404, and a wireless interface 406 which can communicate with a wireless device 408. The communication link between the interface 406 and device 408 may be formed using a variety of different wireless communication mediums (e.g., radio waves or light waves). For example, a communication link using radio waves may be implemented through a spread spectrum technique such as Code Division Multiple Access (CDMA) communication or through a frequency hopping technique such as that disclosed in the Bluetooth specification.

Further depicted in this example is a ROM 410 and a flash memory 412. However, other type of non-volatile memory (e.g., EPROM, or an EEPROM) may be utilized in addition to or in place of ROM 410 and/or flash memory 412. An input controller 414 connects a keyboard 416 and a mouse 418 to computer system 400. Additionally, computer system 400 may include a variety of interface connections for connecting to one or more external devices. For example, computer system 400 may include a serial interface 420 that connects to a serial device 422, a parallel interface 424 that connects to a parallel device 426, a universal serial bus (USB) interface 428 that connects to a universal serial bus device 430, and an IEEE 1394 interface 440 that connects to an IEEE 1394 device 442 (commonly referred to as a fire wire device).

In this example, the various elements of the computer system 400 are connected by a system bus 432. A disk controller 438 is connected to a floppy disk drive 436 and a hard disk drive 434. A communication controller 448 allows the computer system 400 to communicate with other computers (e.g., by sending e-mail messages) over a telephone line 444 or a network 446. An I/O (Input/Output) controller 450 is connected to a printer 452 and a hard disk 454, for example using a SCSI (Small Computer System Interface) bus. Computer system 400 also includes a display controller 460 connected to a CRT (Cathode Ray Tube) 458. However, a variety of other types of display units may be used including, but not limited to a liquid crystal display, a light emitting diode display, a plasma display, etc.

### DISPLAYING DIGITAL IMAGES IN SLIDE-SHOW FORMAT

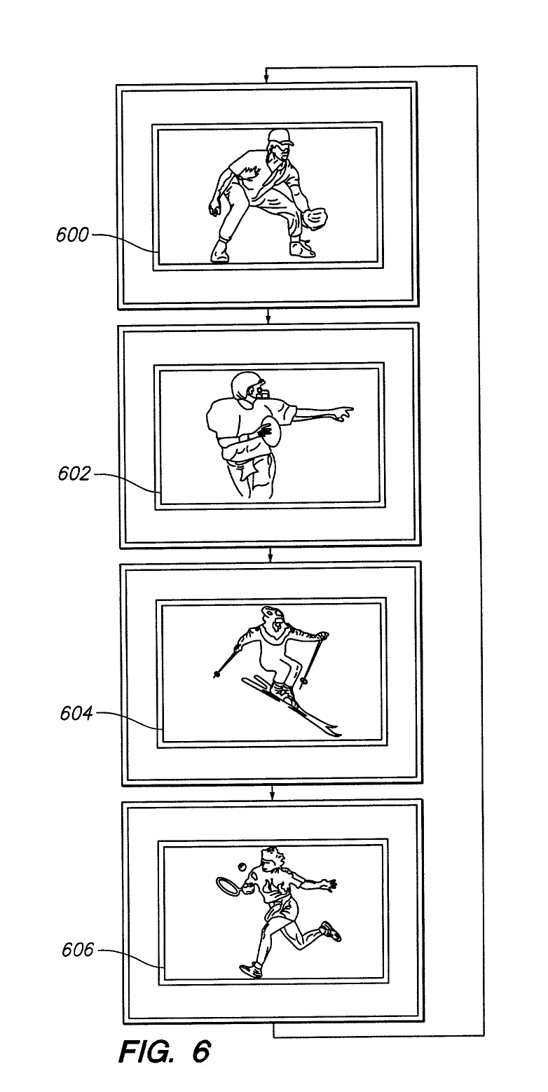

FIG. 6 illustrates an example of a flat panel display system in which multiple picture images are displayed in a slide-show format. In one embodiment, the application software controls which picture is currently displayed on the flat panel display unit and for how long before the next picture is shown. As illustrated in FIG. 6, a picture 600 is displayed on the flat panel display unit. After a selected period of time, a picture 602 is then displayed on the flat panel display unit. Thereafter, a picture 604 and then a picture 606 are sequentially displayed on the flat panel display unit. In certain embodiments, each picture is displayed with the flat panel display unit over an equal time period. In one embodiment, the user may select variable time periods for displaying a plurality of picture with the flat panel display unit. For example, the user may choose to display pictures 600 and 604 for one hour each, while pictures 602 and 606 are displayed for two hours each.

In certain embodiments, flat panel display system continually rotates through the set of selected pictures. For example, after displaying picture 606 for certain period of time, the application software may cause the first picture 600 to again be displayed within the flat panel display unit.

### METHOD FOR DISPLAYING DIGITAL IMAGES ON A FLAT PANEL DISPLAY UNIT

FIG. 7 depicts a flow diagram 700 that illustrates a set of steps that may be taken for displaying images on a flat panel display system. At step 702, in response to powering-up the flat panel display system, the application software is initialized and power is provided to the flat panel display unit. At step 704, the application software loads the set of available pictures from various external sources and stores the pictures in the flat panel digital picture frame. For example, the application software may load a set of thumbnail images from a specific web site and display the thumbnail images on the flat panel display unit. At step 706, the user selects a set of one or more pictures to display on the flat panel display unit. For example, by interacting with the control panel options the user can select one or more thumbnail images that are displayed in the flat panel display unit. At step 708, the user selects the particular mode in which the pictures are to be displayed. For example, the user may select a slide-show mode for displaying the images and a particular time duration for which each image is to be displayed. At step 710, the user may adjust the visual and/or audio settings on the flat panel display unit, such as the lighting or contrast of the flat panel display or the volume of the music that is played. At step 712, once the picture images and the visual and/or audio settings have been selected, the application software displays the selected pictures on the flat panel display unit.

### ALTERNATIVES EXTENSIONS

The flat panel display system that is described herein allows a user to select one or more digital images and to display the images within a flat panel display unit that is attached to a building wall. In addition to selecting the set of one or more images, the user can also select a set of one or more audio titles, for example, one or more songs, that are to be played while a particular image is being displayed within the flat panel display unit.

In describing certain embodiments of the invention, several drawing figures have been used for explanation purposes. However, the invention is not limited to any particular context as shown in drawing figures, and the scope of the invention includes other contexts and applications in which the preview document model described herein is available to other mechanisms, methods, programs, and processes. Thus, the specification and drawings are, accordingly, to be regarded in an illustrative rather than a restrictive sense.

Moreover, within the disclosure, including in the claims, certain process steps are set forth in a particular order, and alphabetic and alphanumeric labels are used to identify certain steps. However, unless specifically stated in the disclosure, embodiments of the invention are not limited to any particular order of carrying out such steps. In particular, the labels are used merely for convenient identification of steps, and are not intended to imply, specify or require a particular order of carrying out such steps.

What is claimed is:

1. A flat panel digital picture apparatus comprising:
a flat panel display unit that is configured for displaying high resolution digital picture information;
a frame component that is configured for mounting to a wall within a building structure and for supporting the flat panel display unit for viewing when mounted to the wall unit; and
a control panel that is associated with said frame component and which allows a user to select one or more digital images for display within said flat panel display unit.

2. The flat panel digital picture apparatus as recited in claim 1, further comprising one or more data ports that are configured for receiving digital image information from one or more remotely located devices.

3. The flat panel digital picture apparatus as recited in claim 2, wherein
at least one of said one or more data ports is connected to a network system; and
wherein, the flat panel digital picture apparatus is configured for retrieving digital image files from resources connected to said network system.

4. The flat panel digital picture apparatus as recited in claim 1, further comprising an audio component, wherein the audio component may be configured to play a specific audio composition whenever a selected image is being displayed within said flat panel display unit.

5. The flat panel digital picture apparatus as recited in claim 1, further comprising a storage unit for storing a plurality of digital images files that may be selected by the user for display within the flat panel display unit.

6. A method for displaying digital images on a flat panel display unit, the method comprising:
receiving one or more digital image files;
displaying a thumbnail image for each of said one or more digital image files;
receiving a first user input that selects one or more of said thumbnail images;
receiving a second user input that selects a particular mode for displaying images associated with said one or more of said thumbnail images; and
displaying within said flat panel display unit, one or more images that are associated with said one or more selected thumbnail images, wherein the one or more images are displayed based on the selected display mode.

7. The method as recited in claim 6, wherein the step of receiving one or more digital image files includes the steps of:
establishing a link to a remotely located resource, wherein the remotely located resource includes a set of one or more digital image files;
requesting delivery of at least one of said one or more digital image files from said remotely located resource; and
receiving, from said remotely located resource, the at least one of said one or more digital image files.

8. The method as recited in claim 7, wherein the step of establishing a link to a remotely located resource includes the step of establishing said link through a wireless communication interface.

9. The method as recited in claim 7, wherein:
the step of establishing a link to a remotely located resource includes the step of said flat panel display unit establishing a communication link to a remote computer device;
the step of requesting delivery includes the step of said flat panel display unit sending, to said remote computer device, a request for delivery of a digital image file; and
the step of receiving includes the step of receiving at said flat panel display unit, the at least one of said one or more digital image files from said remote computer device.

10. The method as recited in claim 9, wherein:
the step of said flat panel display unit establishing a communication link includes the step of said flat panel display unit automatically establishing a communication link to said remote computer device on a predefined periodic interval;
the step of said flat panel display unit sending, includes the step of, in response to establishing a connection to said remote computer device based on said predefined periodic interval, said flat panel display unit requesting delivery of one or more new digital images from said remote computer device, wherein said one or more new digital images are distinct from said one or more images that are currently being displayed on said flat panel display unit;
the step of receiving at said flat panel display unit includes the step of receiving said one or more digital image files that are associated with said one or more new digital images; and
the step of displaying includes the step of displaying within said flat panel display unit said one or more new digital images.

11. A computer-readable medium carrying one or more sequences of instructions for displaying digital images on a flat panel display unit, wherein execution of the one or more sequences of instructions by one or more processors causes the one or more processors to perform the steps of:
receiving one or more digital image files;
displaying a thumbnail image for each of said one or more digital image files;
receiving a first user input that selects one or more of said thumbnail images;
receiving a second user input that selects a particular mode for displaying images associated with said one or more of said thumbnail images; and
displaying within said flat panel display unit, one or more images that are associated with said one or more selected thumbnail images, wherein the one or more images are displayed based on the selected display mode.

12. The computer-readable medium as recited in claim 11, wherein the step of receiving one or more digital image files includes the steps of:
establishing a link to a remotely located resource, wherein the remotely located resource includes a set of one or more digital image files;
requesting delivery of at least one of said one or more digital image files from said remotely located resource; and
receiving, from said remotely located resource, the at least one of said one or more digital image files.

13. The computer-readable medium as recited in claim 12, wherein the step of establishing a link to a remotely located resource includes the step of establishing said link through a wireless communication interface.

14. The computer-readable medium as recited in claim 12, wherein:
the step of establishing a link to a remotely located resource includes the step of said flat panel display unit establishing a communication link to a remote computer device;
the step of requesting delivery includes the step of said flat panel display unit sending, to said remote computer device, a request for delivery of a digital image file; and
the step of receiving includes the step of receiving at said flat panel display unit, the at least one of said one or more digital image files from said remote computer device.

15. The computer-readable medium as recited in claim 14, wherein:
the step of said flat panel display unit establishing a communication link includes the step of said flat panel display unit automatically establishing a communication link to said remote computer device on a predefined periodic interval;
the step of said flat panel display unit sending, includes the step of, in response to establishing a connection to said remote computer device based on said predefined periodic interval, said flat panel display unit requesting delivery of one or more new digital images from said remote computer device, wherein said one or more new digital images are distinct from said one or more images that are currently being displayed on said flat panel display unit;
the step of receiving at said flat panel display unit includes the step of receiving said one or more digital image files that are associated with said one or more new digital images; and
the step of displaying includes the step of displaying within said flat panel display unit said one or more new digital images.
